(19) United States
(12) Patent Application Publication
(10) Pub. No.: US 2008/0309957 A1
(43) Pub. Date: Dec. 18, 2008

(54) Image forming apparatus and image forming method

(75) Inventors: Yoshimine Horiuchi, Yokohama-shi (JP); Yasuhiro Hattori, Yokohama-shi (JP); Satoru Ohno, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/155,506

(22) Filed: Jun. 5, 2008

(30) Foreign Application Priority Data
Jun. 14, 2007 (JP) 2007-157898

(51) Int. Cl. H04N 1/50

(52) U.S. Cl. 358/1.9

(57) ABSTRACT

Information controlling image processing or image forming performed on image data of a document is embedded into the image data as control data. When the control data is detected in the image data, the control data is analyzed to determine specific image processing or image forming to be performed on each page of the image data.

### CROSS-REFERENCE TO RELATED APPLICATIONS

This patent application is based on and claims priority under 35 U.S.C. §119 to Japanese Patent Application No. 2007-157898, filed on Jun. 14, 2007, in the Japanese Patent Office, the disclosure of which is hereby incorporated by reference.

### BACKGROUND

A recent image forming apparatus may be additionally provided with a plurality of functions other than the function of forming an image on a recording medium. For example, the Japanese Patent No. 3236898 discloses an image processor capable of determining whether the image data being scanned is skewed using a mark that is extracted from the image data of the document. In order to determine whether the image data is skewed, the image processor disclosed in the Japanese Patent No. 3236898 compares the physical shape of the mark that is extracted from the image data with the physical shape of the mark that is obtained from the image data having the upright position, as the mark itself contains no information regarding the orientation of the image data.

### SUMMARY

In view of the above, the inventors of the present invention have discovered that, if the mark itself can have information regarding the orientation of the image data, an image forming apparatus may be able to determine the orientation of the image data more efficiently without the need of comparing the physical shape of the mark. Further, the inventors of the present invention have discovered that, if there is a technique that allows the mark to have information regarding the orientation of the image data, various kinds of information regarding the image data may be added in the form of mark, which may be used to facilitate the effective use of the image forming apparatus.

Example embodiments of the present invention include an image forming apparatus capable of adding control data to image data of a document. The control data may be any desired kind of information that may control specific image processing or image forming being performed on each page of the image data of the document. In one example, embedded position information specifying a portion of the image data in which the control data is embedded may be embedded as the control data. In another example, page number information at least specifying a page number being assigned to each page of the document may be embedded as the control data. Any other desired kind of information, such as double-sided information controlling double-sided printing or post processing information controlling post processing, may be embedded as the control data.

Other embodiments of the present invention include an image forming apparatus capable of extracting control data from image data of a document. When the control data is detected in at least a portion of the image data, the image forming apparatus may analyze the control data, and perform image processing or image forming operation according to the result of analysis.

For example, when the control data includes embedded position information specifying a portion of the image data to which the control data is embedded, the image forming apparatus may determine whether the image data being input has a predetermined orientation based on the embedded position information, and rotates the image data when necessary before outputting the image data as output data.

In another example, when the control data includes page number information specifying at least a page number being assigned to each page of the document, the image forming apparatus may determine whether the order in which the image data is input matches a predetermined order obtainable from the page number information, and rearrange the order in which the image data is arranged when necessary before outputting the image data as output data.

In addition to the above-described example embodiments, the present invention may be practiced in various other ways, for example, as an image forming system capable of performing the above-described function, as an image forming method, or a computer readable recording medium including a plurality of computer program instructions that causes a computer to execute the above-described function or the image forming method.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating the hardware structure of an image forming apparatus according to an example embodiment of the present invention;

FIG. 2 is a schematic block diagram illustrating the software structure of the image forming apparatus shown in FIG. 1 according to an example embodiment of the present invention;

FIG. 3 is a flowchart illustrating operation of adding control data to a document, performed by the image forming apparatus of FIG. 1, according to an example embodiment of the present invention;

FIG. 4 is a flowchart illustrating operation of extracting control data from a document and perform image forming according to the control data, performed by the image forming apparatus of FIG. 1, according to an example embodiment of the present invention;

FIG. 5A is an example illustration of the document embedded with the control data, generated by the image forming apparatus of FIG. 1;

FIG. 5B is an example illustration of image data of the document shown in FIG. 5A, having an orientation of 0 degree;

FIG. 5C is an example illustration of the image data of the document shown in FIG. 5A, having an orientation of 90 degrees;

FIG. 5D is an example illustration of the image data of the document shown in FIG. 5A, having an orientation of 180 degrees;

FIG. 5E is an example illustration of the image data of the document shown in FIG. 5A, having an orientation of 270 degrees;

FIG. 6 is an example table storing a plurality of rotation angle values with respect to a plurality of sets of embedded position information and detected position information;

FIG. 7 is a flowchart illustrating operation of determining the value of a rotation angle based on control data, performed by the image forming apparatus of FIG. 1, according to an example embodiment of the present invention;

FIG. 8A is an example illustration of the document embedded with the control data, generated by the image forming apparatus of FIG. 1;

FIG. 8B is an example illustration of the image data of the document shown in FIG. 8A, having an orientation of 0 degree;

FIG. 8C is an example illustration of the image data of the document shown in FIG. 8A, having an orientation of 90 degrees;

FIG. 8D is an example illustration of the image data of the document shown in FIG. 8A, having an orientation of 180 degrees;

FIG. 8E is an example illustration of the image data of the document shown in FIG. 8A, having an orientation of 270 degrees;

FIG. 9 is an example table storing a plurality of rotation angle values with respect to a plurality of sets of embedded position information and detected position information;

FIG. 10 is a flowchart illustrating operation of determining the value of a rotation angle based on control data, performed by the image forming apparatus of FIG. 1, according to an example embodiment of the present invention;

FIG. 11A is an example illustration of a plurality of pages of a document input to the image forming apparatus of FIG. 1;

FIG. 11B is an example illustration of a plurality of pages of the document shown in FIG. 11A, output from the image forming apparatus of FIG. 1;

FIG. 12A is an example illustration of a plurality of pages of a document input to the image forming apparatus of FIG. 1;

FIG. 12B is an example illustration of a plurality of pages of the document shown in FIG. 12A, output from the image forming apparatus of FIG. 1

FIG. 13A is an example illustration of a plurality of pages of a document input to the image forming apparatus of FIG. 1;

FIG. 13B is an example illustration of a plurality of pages of the document shown in FIG. 13A, output from the image forming apparatus of FIG. 1

FIG. 14A is an example illustration of a plurality of pages of a document input to the image forming apparatus of FIG. 1;

FIG. 14B is an example illustration of a plurality of pages of the document shown in FIG. 14A, output from the image forming apparatus of FIG. 1;

FIG. 15A is an example illustration of a plurality of pages of a document input to the image forming apparatus of FIG. 1;

FIG. 15B is an example illustration of a plurality of pages of the document shown in FIG. 15A, output from the image forming apparatus of FIG. 1;

FIG. 16 is an example illustration of a plurality of pages of a document input to the image forming apparatus of FIG. 1;

FIG. 17A is an example illustration of a plurality of pages of a document input to the image forming apparatus of FIG. 1;

FIG. 17B is an example illustration of a plurality of pages of the document shown in FIG. 17A, output from the image forming apparatus of FIG. 1; and

FIG. 18 is an equation used for rotating image data, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

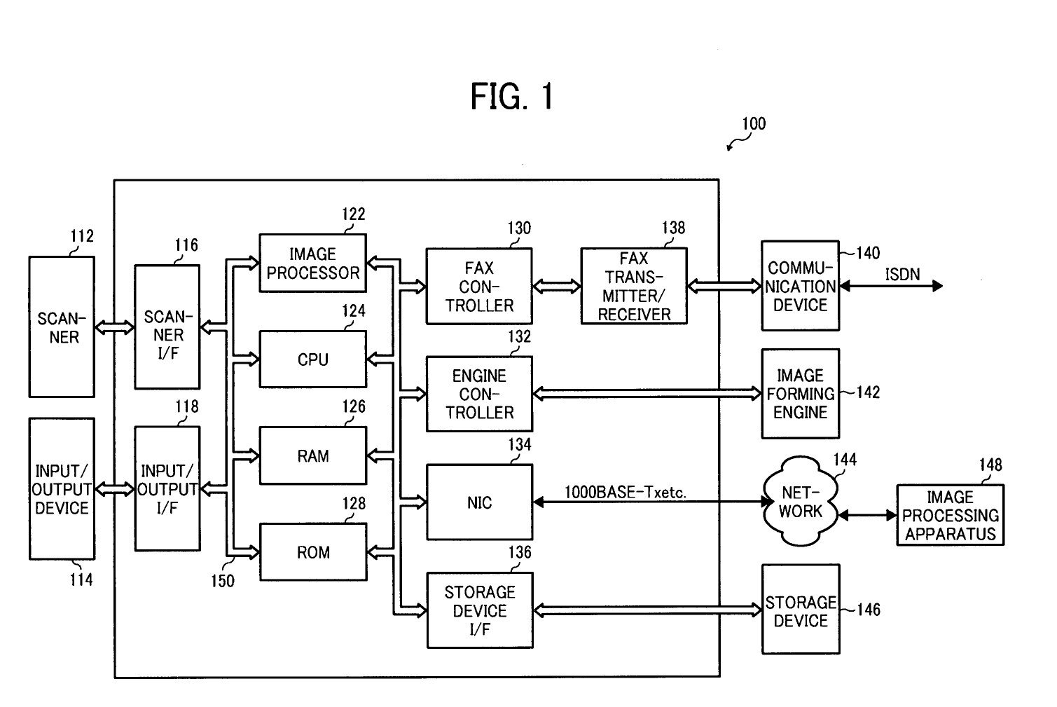

Referring now to the drawings, wherein like reference numerals designate identical or corresponding parts throughout the several views, FIG. 1 illustrates a hardware structure of an image forming apparatus 100 according to an example embodiment of the present invention. The image forming apparatus 100 mainly includes a scanner 112, an input/output device 114, a scanner interface (I/F) 116, an input/output interface (I/F) 118, an image processor 122, a central processing unit (CPU) 124, a random access memory (RAM) 126, a read only memory (ROM) 128, a facsimile (fax) controller 130, an engine controller 132, a network interface controller (NIC) 134, a storage device interface (I/F) 136, a facsimile (fax) transmitter/receiver 138, a communication device 140, an image forming engine 142, and a storage device 146. As shown in FIG. 1, the above-described elements may be connected via a bus 150.

The scanner 112 scans a document into image data, and sends the image data to the image processor 122 through the scanner I/F 116. The scanner 112 may have any desired structure. For example, the scanner 112 may be provided with an automatic document feeder (ADF), which feeds the document to an image reading section of the scanner 112.

The input/output device 114 allows the user to communicate with the image forming apparatus 100 through the input/output I/F 118. For example, the input/output device 114 may include an input device capable of inputting a user instruction, such as a button, key, microphone, keyboard, etc., and an output device capable of outputting information generated by the image forming apparatus 100, such as a display, buzzer, speaker, etc. The input/output device 114 may be provided in the form of an operation panel having a touch-panel screen.

The image processor 122 applies various image processing to the image data, which may be received from the scanner 112 through the scanner I/F 116 or from the outside of the apparatus 100 through the fax controller 130, the NIC 134 or the storage device I/F 136. For example, the image processor 122 may apply various image processing, such as filtering, skew correction, character data extraction, and/or halftone data extraction, to the image data received from the scanner 112 to generate processed image data. The image processor 122 may further send the processed image data to the engine controller 132 for printing. Alternatively, the image processor 122 may store the processed image data in any desired memory or storage device, such as the RAM 126 or the storage device 146.

In this example, the image processor 122 includes a control data processor 123. In one example, the image processor 122 may generate control data, and add the control data to the image data in the form of a mark according to a user instruction input by the input/output device 114. Alternatively, the control data processor 123 may extract control data, which has been added to the image data in the form of mark, from the image data, and perform image forming according to the control data.

The fax controller 130 may convert the processed image data to fax image data, such as the fax image data having G3 or G4 format. The fax transmitter/receiver 138 may be implemented by any desired communication device, such as a modem, which allows the fax controller 130 to communicate through a public switched telephone network (PSTN). The communication device 140 may be implemented by any desired communication device, such as a digital service unit (DSU) and terminal adopter (TA), a TA incorporating the DSU, etc., which allows the fax controller 130 to communicate through an integrated services digital network (ISDN). In addition to the function of sending or receiving fax image data, the facsimile controller 130 may receive or send email data using the point-to-point protocol (PPP).

The engine controller 132 causes the image forming engine 142 to form an image using information contained in the processed image data according to the default settings of the image forming apparatus 100 or the settings set by the user. The engine controller 132 may control operation of the image forming engine 142 directly or through a bus such as a universal serial bus (USB), IEEE 1284, or peripheral component interconnect (PCI).

The image forming engine 142 may include a plurality of devices to be used for image forming, including an exposure device, charging device, photoconductor such as a photoconductive drum, developing device, transfer device including an intermediate transfer body, a fixing device, etc.

The NIC 134 may be implemented by, for example, a network interface card, which allows the image forming apparatus 100 to communicate through a network 144 in compliance with the Ethernet such as 1000BASE-TX. The network 144 may include a local area network (LAN), a wide area network (WAN), or the Internet. For example, the image forming apparatus 100 may function as a remote printer that may be used by a plurality of users through the LAN. In another example, the image forming apparatus 100 may be provided with the function of sending or receiving email data in compliance with the SMTP/POP protocol. In another example, the image forming apparatus 100 may communicate with the outside apparatus, such as an information processing apparatus 148, through the network such as the Internet to provide a plurality of functions including the function of storing various data in the information processing apparatus 140 or reading out various data from the information processing apparatus 140. In this example, the image processing apparatus 140 may function as a directory server or a file server.

The storage device I/F 136 may allow the image forming apparatus 100 to communicate with the storage device 146 in compliance with any desired standard such as Small Computer System Interface (SCSI), Universal Serial Bus (USB), or the Advanced Technology Attachment (ATA) standards including, for example, Serial ATA, ATA Packet Interface (ATAPI), or ATA-4. The storage device 146 may be implemented by, for example, a hard disk drive, secure digital (SD) card, memory stick, digital versatile disc (DVD), magneto-optical (MO) disc, or flexible disk. For example, the storage device 146 may store any desired data, such as the image data obtained by the scanner 112 or address data.

The CPU 124 may function as a system controller, which controls operation of the image forming apparatus 100. The CPU 124 may be implemented by any desired processor including, for example, Pentium-based processor, Pentium IV-based processor, Pentium compatible processor, Power PC-based processor, or MIPS-based processor. In this example, the CPU 124 may manage operation of the image forming apparatus 100 using method invocation.

The RAM 126 may function as a work area of the CPU 124, a buffer area for storing the processed image data, a buffer area for storing the user instruction, or a bitmap memory for storing video data converted from the processed image data. In this example, the RAM 126 may be implemented by volatile memory and/or non-volatile memory.

The ROM 128 may store various data including a control data encoding program or a control data decoding program to be executed by the CPU 124. For example, upon activation of the image forming apparatus 100 or upon receiving a request from the user, the CPU 124 may load the control data encoding or decoding program from the ROM 128 onto the RAM 126, and perform encoding or decoding according to the loaded program. In such case, the RAM126 may function as a work memory of the CPU 124. Alternatively, the program may be stored in any other memory or storage device, such the storage device 146 or information processing apparatus 148.

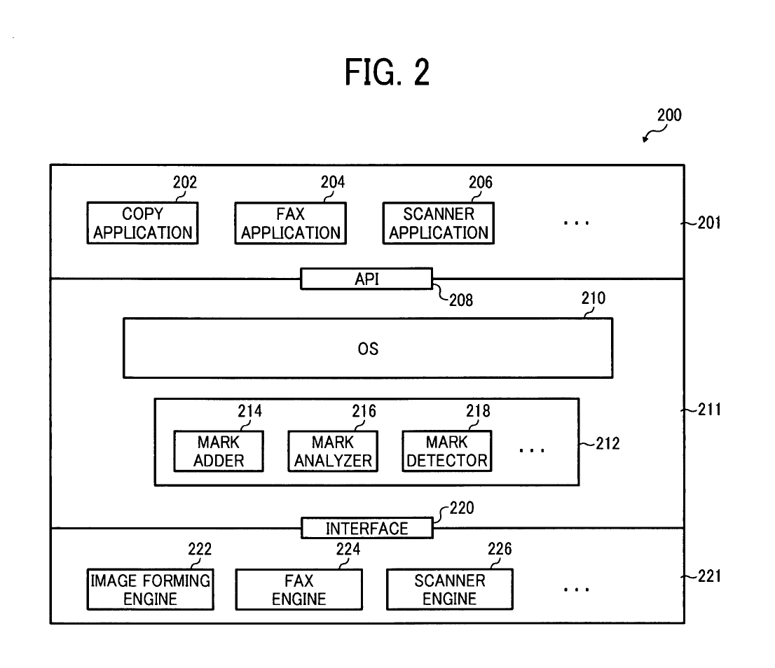

Referring now to FIG. 2, a software structure 200 of the image forming apparatus 100 is explained according to an example embodiment of the present invention. The image forming apparatus 100 may include an application module 201, an operating system (OS) module 211, an engine module 221, an application program interface (API) 208, and an interface 220.

The application module 201 includes one or more application programs each of which provides a specific function to the image forming apparatus 100 when run on the OS 210. In this example, the application module 201 includes a copy application 202 that provides the function of copying, a fax application 204 that provides the function of sending or receiving data via facsimile, and a scanner application 206 that provides the function of scanning. Additionally, the application module 201 may include a web application that provides the function of communicating via the Internet. In this example, the application program may be written in any desired programming language, such as the object-oriented programming language including, for example, C, C++, Visual C++, Visual Basic, or Java.

The OS module 211 includes an OS 210 and a library 212. Examples of the OS 210 include, but not limited to, Mac OS, Windows, Windows 200X Server, UNIX, and LINUX. The library 212 includes a mark adder 214, a mark analyzer 216, and a mark detector 218, each of which may function as the control data processor 123 of FIG. 1. Further, the library 212 may additionally include a post processing object capable of performing post processing operation, such as the processing object capable of stapling a document, the processing object capable of punching a document, and/or the processing object capable of sorting a document.

The engine module 221 outputs data to the outside. In this example, the engine module includes an image forming engine 222, a facsimile (FAX) engine 224, and a scanner engine 224. In this example, the image forming engine 222 may correspond to the image forming engine 142 of FIG. 1. The fax engine 224 may correspond to any one of the fax controller 130, the fax transmitter/receiver 138, and the communication device 140 of FIG. 1. The scanner engine 224 may correspond to the scanner 112 of FIG. 1.

In operation, when a user instruction is received, the corresponding one of the applications 202, 204, and 206 accesses the OS 210 through the API 208, and requests for a processing object requested by the user instruction. The OS 210 calls the requested processing object from the library 212, generates output data according to the user instruction using the processing object of the library 212, and sends the output data to the engine module 221 through the interface 220. The output data is output through at least one of the imaging forming engine 222, fax engine 224, and scanner engine 226.

In one example operation, the image forming apparatus 100 may receive a user instruction, through a user interface such as the input/output device 114 of FIG. 1, which instructs the image forming apparatus 100 to perform the job of encoding control data. In order to encode control data, the scanner application 206 accesses the OS 210 through the API 208, and requests for a processing object capable of performing the job of encoding control data. The OS 210 calls the library 212 to obtain the requested processing object, specifically the mark adder 214, and generates output data according to the user instruction using the mark adder 214. In this example, the mark adder 214 encodes the control data into a mark, and adds the mark to the image data to generate output data. The OS 210 outputs the output data to the engine module 221 through the interface 220. Depending on the user instruction, the output data may be output through the image forming engine 222. Alternatively, the output data may be stored in a memory of the image forming apparatus 100 of FIG. 1 such as the RAM 126 or ROM 128, or in the storage device 146.

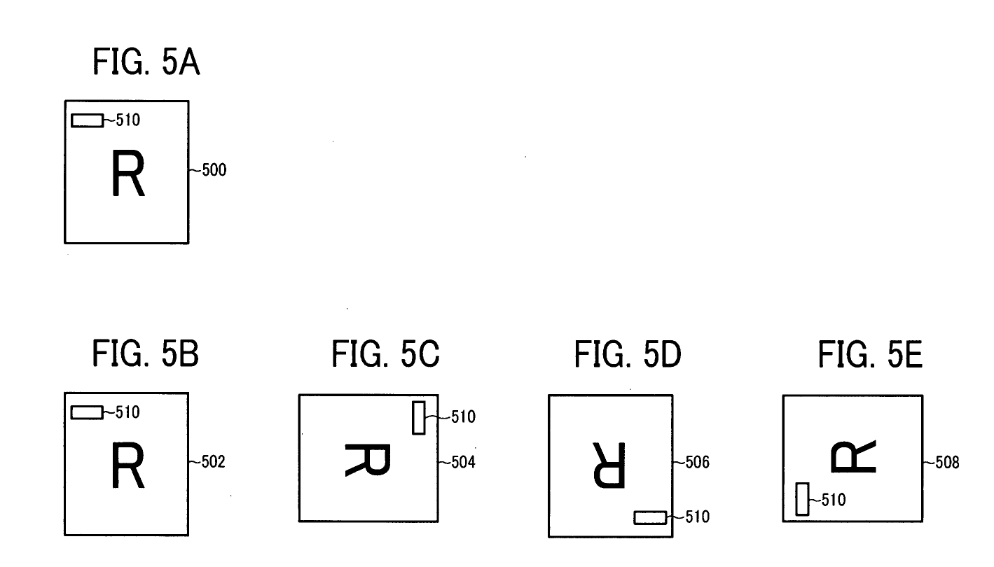

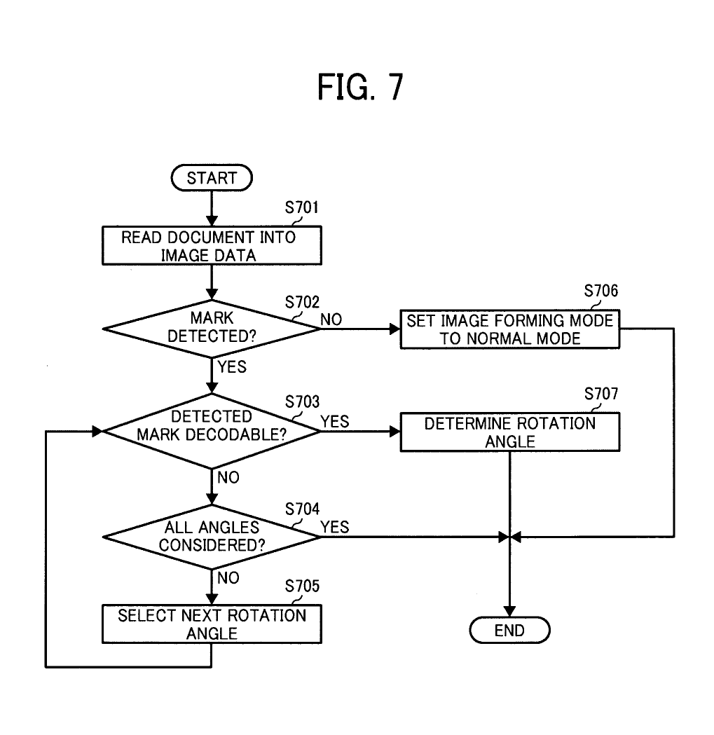

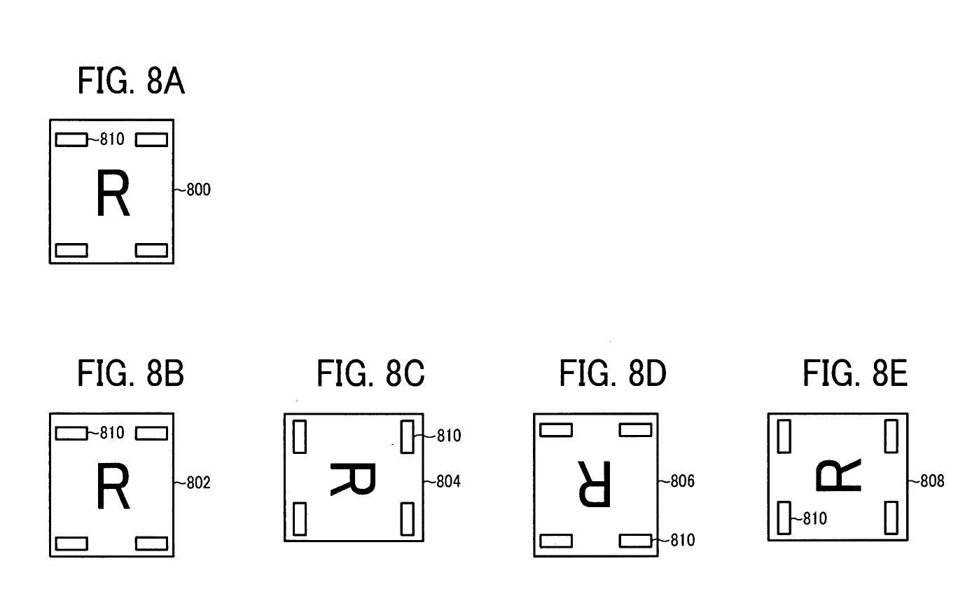

In this example, the mark may be expressed as a code of any desired dimension such as a bar code or a quick response (QR) code, which may be embedded into at least one portion of the image data, such as a portion corresponding to an edge portion of the document as illustrated in FIG. 5A or FIG. 8A. Alternatively, the mark may be expressed as any desired number of patterns, which may be embedded into at least one portion of the image data or a background layer of the image data. Further, the mark may be embedded in a manner not perceptible to the human eye, for example, as a watermark. Further, in this example, the mark may be generated in the form of raster image. Alternatively, the mark may be generated in the form of Portable Document Format (PDF) or Postscript, which may be converted from the raster image.

The control data to be embedded into the image data may be any desired kind of information, which may influence image processing operation or image forming operation of the image data. Examples of such information include, but not limited to, embedded position information, page number information, and various kinds of printing property information that controls how the image data is printed such as double-sided information and/or post processing information.

The embedded position information may specify the portion of the image data to which the control data is embedded. The page number information may indicate the page number assigned to each page of the original document, the last page number of the original document, and/or the total number of pages of the original document, for example, when the original document includes a plurality of pages. The double-sided information may indicate whether the image data is to be printed on one side of the recording medium or both sides of the recording medium and/or specifying a direction of opening when the image data is formed on both sides of the recording medium. The post processing information may control post processing process to be performed on the printed document such as whether stapling or punching is needed, a portion of the image data subjected for stapling or punching, and/or whether to sort a plurality of pages.

The other kinds of printing property information may include information regarding the size of the image data, desired image quality of the image data, the size or type of the recording medium on which the image data is to be printed, the color mode to be used for image forming, the direction of the document being output, whether book binding process is to be performed, whether to rotate the image data when printing, and/or whether to enlarge or reduce the size of the image data. The type of information to be embedded as control data may be previously set by default or according to the user preference.

In another example operation, the image forming apparatus 100 may receive a user instruction, through the user interface such as the input/output device 114 of FIG. 1, which instructs the image forming apparatus 100 to perform the job of decoding control data. In order to decode control data, the scanner application 206 accesses the OS 210 through the API 208, and requests for a processing object capable of performing the job of decoding the control data. The OS 210 calls the library 212 to obtain the requested processing object, specifically the mark detector 218 and the mark analyzer 216. The mark detector 218 detects the mark in the image data, and extracts the mark from a portion of the image data in which the mark is detected. The mark analyzer 216 decodes the mark, which is extracted from the image data, into the control data, and analyzes the control data to determine specific image processing operation or image forming operation to be performed on the image data. The mark analyzer 216 generates output data, which corresponds to the image data to be printed, based on the information contained in the control data. The OS 210 outputs the output data to the engine module 221 through the interface 220. The output data may be output through the image forming engine 222.

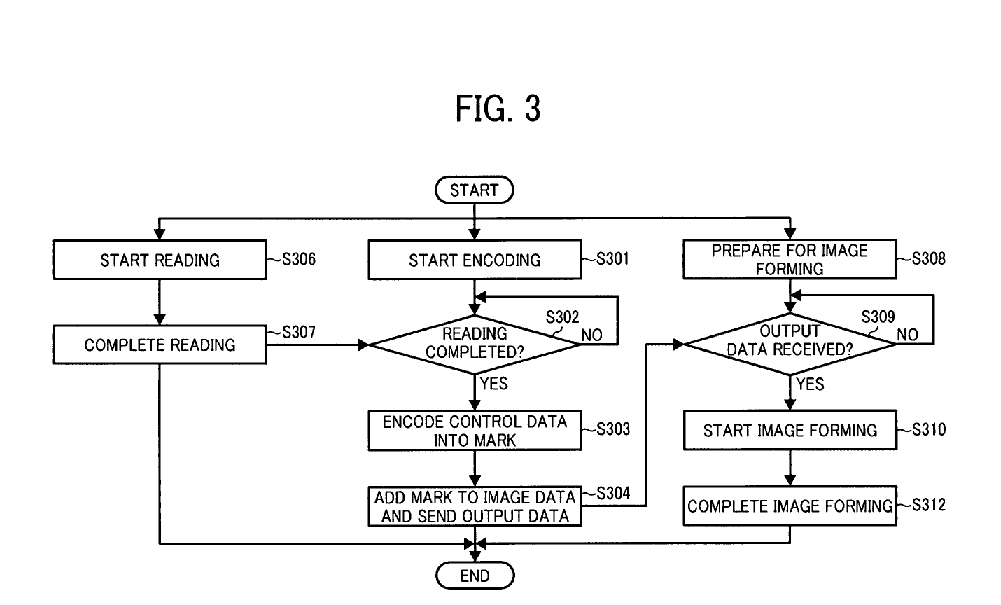

Referring now to FIG. 3, operation of adding control data to an original document, performed by the image forming apparatus 100, is explained according to an example embodiment of the present invention. The operation of FIG. 3 may be performed by the CPU 124 (FIG. 1) when a user instruction for performing the job of adding the control data to the original document is received. In such case, the user may provide the original document to the scanner 112 (FIG. 1), for example, by placing the original document on an exposure glass of the scanner 112 or on a document tray of the ADF of the scanner 112. When the user instruction for adding the control data is received through the input/output device 114 (FIG. 1), the CPU 124 communicates with the scanner 112, the image processor 122 (FIG. 1), and the image forming engine 142 (FIG. 1) using any desired interprocess communication technique such as socket or signal to respectively start operation of S306, S301, and S308. Since the CPU 124 is capable of performing a plurality of jobs concurrently, operation of adding the control data may be efficiently performed.

At S306, the scanner 112 starts reading the original document into image data. The scanner 112 may send the image data being obtained sequentially to the image processor 122. Alternatively, the scanner 112 may store the image data being obtained in a memory, and send the image data to the image processor 122 after reading is completed.

At S301, the image processor 122 prepares for operation of encoding control data. For example, the image processor 122 obtains information to be embedded as the control data, which may be set by default or according to the user preference. Further, the image processor 122 may determine a type of the mark to which the control data is encoded according to the default setting or according to the user preference. Further, the image processor 122 may determine a portion of the image data to which the control data is added, which may be set by default or according to the user preference.

At S308, the image forming engine 142 is activated to prepare for image forming, for example, by activating one or more devices to be used for image forming.

When reading operation of the scanner 112 is completed at S307, the scanner 112 notifies the image processor 122 that reading operation is completed, and the operation ends.

The image processor 122 waits for notification from the scanner 112 at S302. When it is determined that notification is not received (“NO” at S302), the operation repeats S302 to wait for notification. When it is determined that notification is received (“YES” at S302), operation proceeds to S303.

At S303, the image processor 122 encodes the control data into the mark. In one example, the control data may include embedded position information specifying a portion of the image data to which the control data is embedded. The embedded position information may be previously set by default. Alternatively, the embedded position information may be set by the user every time the job of encoding the control data is performed, for example, through the input/output device 114.

At S304, the image processor 122 adds the mark generated at S303 to a portion of the image data to generate output data. In one example, the portion of the image data to which the image data is added may be previously determined according to the default settings or according to the user preference, when the embedded position information of the control data, which is encoded into the mark, is determined. In order to add the mark to the right portion of the image data, the image processor 122 obtains information regarding an orientation of the document.

For example, at the time of reading the document into the image data, information regarding the orientation of the document may be obtained, which indicates whether the document is in the portrait orientation or in the landscape orientation. Information regarding the orientation of the document may be obtained from the user instruction input through the input/output device 114. Alternatively, such information may be set by default. Alternatively, such information may be obtained from a sensor of the scanner 112, which is capable of detecting the size and/or orientation of the document being placed on the exposure glass of the scanner 112. Alternatively, such information may be obtained from a sensor of the ADF, which is capable of detecting the size and/or orientation of the document being placed on the document tray of the ADF. Based on the information regarding the orientation of the document and the information regarding the portion to which the control data is embedded, the image processor 122 specifies a portion of the image data to which the mark is added, and adds the mark to the specified portion to generate output data. The output data may be stored in a memory. When an instruction for printing is received, for example, from the CPU 124, the image processor 122 sends the output data to the image forming engine 142, and the operation ends. Alternatively, the output data may be sent, page by page, to the image forming engine 142.

For example, when the control data is determined to be embedded to an upper left portion of the image data, and the orientation of the document is set to the portrait, as illustrated in FIG. 5A, the mark such as a mark 510 is added to the upper left portion of the image data 500 of the document that is in the portrait orientation. In another example, when the control data is determined to be embedded to an upper left portion of the image data, and the orientation of the document is set to the landscape, as illustrated in FIG. 12A, the mark is added to the upper left portion of the image data of the document that is in the landscape orientation.

Referring back to FIG. 3, at S309, the image forming engine 142 waits for the output data, which may be sent from the image processor 122. When it is determined that the output data is not received (“NO” at S309), the operation repeats S309. When it is determined that the output data is received (“YES” at S309), the operation proceeds to S310.

At S310, the image forming engine 142 may store the output data obtained from the image processor 122 in a memory such as a first-in first-out (FIFO) buffer. The image forming engine 142 may read out the output data, page by page, from the memory, and form an image of the output data on a recording medium.

When image forming is completed for all pages of the output data at S312, the operation ends.

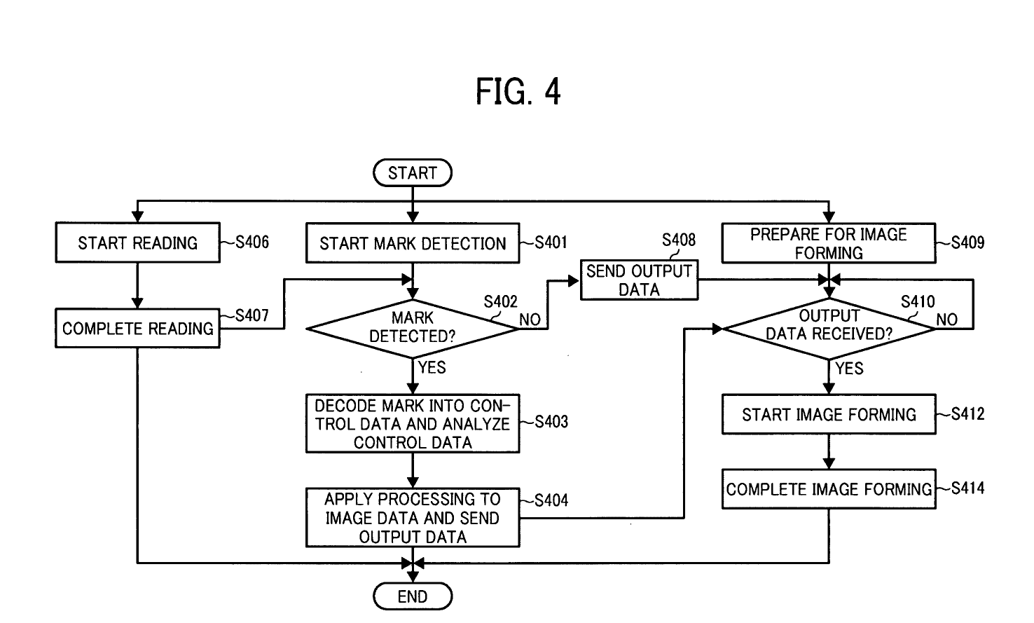

Referring now to FIG. 4, operation of forming an image according to control data extracted from a document, performed by the image forming apparatus of FIG. 1, is explained according to an example embodiment of the present invention. The operation of FIG. 4 may be performed by the CPU 124 (FIG. 1) when a user instruction for performing the job of forming the image of a document according to control data extracted from the image data, is received. In such case, the user may provide the document embedded with the control data to the scanner 112 (FIG. 1), for example, by placing the document on an exposure glass of the scanner 112 or on a document tray of the ADF if the ADF is provided. When the user instruction for performing image forming according to control data is received through the input/output device 114 (FIG. 1), the CPU 124 (FIG. 1) communicates with the scanner 112, the image processor 122, and the image forming engine 142 using any desired interprocess communication technique to respectively start operation of S406, S401, and S409. Since the CPU 124 is capable of performing a plurality of jobs concurrently, operation of performing image forming according to the control data may be efficiently performed.

At S406, the scanner 112 starts reading the document into image data. The scanner 112 may send the image data being obtained sequentially to the image processor 122. Alternatively, the scanner 112 may store the image data being obtained in a memory.

At S401, the image processor 122 prepares for operation of decoding control data. For example, the image processor 122 may start detecting a mark in the image data received from the scanner 112. In order to detect the mark, the image processor 122 may obtain information regarding the orientation of the document such as whether the document is in the portrait or landscape orientation, which may be set by default or obtainable from the scanner 112 or the input/output device 114. Further, the image processor 122 may look for a specific portion of the image data, which may correspond to the portion of the image data to which the control data is added, when the image processor 122 is provided with information regarding the portion to which the control data is added.

At S409, the image forming engine 142 is activated to prepare for image forming.

When reading operation of the scanner 112 is completed at S407, the scanner 112 notifies the image processor 122 that reading operation is completed, and the operation ends.

The image processor 122 receives the image data being obtained by the scanner 112, and stores the image data in a memory such as a first-in first-out (FIFO) buffer. At S402, the image processor 122 determines whether the mark is detected in the image data. When it is determined that the mark is not detected (“NO” at S402), the operation proceeds to S408. When it is determined that the mark is detected (“YES” at S402), the operation proceeds to S403.

At S408, the image processor 122 sends the image data being obtained by the scanner 112 to the image forming engine 142.

At S403, the image processor 122 extracts the mark from the image data, decodes the mark into the control data, and analyzes the control data to determine image processing or image forming to be performed on the image data. The result of analysis may be stored, for example, as attribute information in a corresponding manner with the image data.

At S404, the image processor 122 performs image processing to the image data according to the control data to generate output data, and sends the output data to the image forming engine 142. At this time, an instruction for starting image forming may be sent to the image forming engine 142 under control of the CPU 124. When all image data being obtained by the scanner 112 is processed and output to the image forming engine 142, the operation ends.

In this example, the image processor 122 may delete the mark when generating the output data. Alternatively, the image processor 122 may keep the mark at the detected portion of the image data. Alternatively, the image processor 122 may change the contents of the mark when generating the output data.

Referring back to FIG. 4, at S410, the image forming engine 142 waits for the output data, which may be sent from the image processor 122. When it is determined that the output data is not received (“NO” at S410), the operation repeats S410. When it is determined that the output data is received (“YES” at S410), the operation proceeds to S412.

At S412, the image forming engine 142 may store the output data obtained from the image processor 122 in a memory such as a FIFO buffer. The image forming engine 142 may read out the output data, page by page, from the memory, and form an image of the output data on a recording medium.

When image forming is completed for all pages of the output data at S414, the operation ends.

Referring now to FIGS. 5A to 5E, operation of extracting a mark, analyzing control data decoded from the extracted mark, and performing image processing or image forming according to the control data, performed by the image forming apparatus 100 of FIG. 1, is explained according to an example embodiment of the present invention.

In this example, the document 500 of FIG. 5A is assumed to be provided to the scanner 112, for example, by placing the document 500 onto the exposure glass of the scanner 112 or placing the document 500 onto the document tray of the ADF of the scanner 112. As illustrated in FIG. 5A, the document 500 is embedded with the mark 510. In this example, the mark 510 is generated by encoding control data, which includes embedded position information specifying that the mark 510 is added to the upper left portion of the image data of the document 500 when the document 500 is in the upright position.

In this example, the image data being obtained by the scanner 112 is assumed to be one of the image data shown in FIGS. 5B to 5E. The image data 502 of FIG. 5B is obtained by the scanner 112 when the document 500 is input with an orientation of 0 degrees from the upright position. The image data 504 of FIG. 5C is obtained by the scanner 112 when the document 500 is input with an orientation of 90 degrees from the upright position. The image data 506 of FIG. 5D is obtained by the scanner 112 when the document 500 is input with an orientation of 180 degrees from the upright position. The image data 508 of FIG. 5E is obtained by the scanner 112 when the document 500 is input with an orientation of 270 degrees from the upright position. Alternatively, a plurality of documents 500 may be input to the scanner 112 each of which may have an orientation different from one another. Further, in this example, the degree of orientation is defined in the clockwise direction. Alternatively, the degree of orientation may be defined in the counterclockwise direction. For the descriptive purpose, in this example operation, the image data 506 of FIG. 5D is assumed to be obtained by the image processor 122 as the image data of the document 500.

As described above referring to S402 of FIG. 4, the image processor 122 determines whether the mark 510 is detected from a portion of the image data 506 of FIG. 5D. In this example, the image processor 122 may firstly determine whether an upper left portion of the image data 506 contains the mark 510. When it is determined that the mark 510 is not detected from the upper left portion of the image data 506, the image processor 122 may determine whether any one of an upper right portion, a lower right portion, and a lower left portion of the image data 506 contains the mark 510, for example, by checking the edge portions of the image data 506 in a predetermined order. As illustrated in FIG. 5D, when the mark 510 is detected from the lower right portion of the image data 506, the image processor 122 may store detected position information specifying the portion of the image data in which the mark 510 is detected, which is the lower right portion of the image data 506.

As described above referring to S403 of FIG. 4, the image processor 122 decodes the mark 510 to obtain control data, and analyzes the control data to determine specific image processing or image forming to be performed on the image data. In this example, the control data includes the embedded position information specifying the portion of the image data of the document 500 to which the mark 510 is added, specifically, the upper left portion of the image data. The image processor 122 may store the embedded position information.

Using the embedded position information and the detected position information, the image processor 122 may determine the value of a rotation angle that causes the image data 506, which is obtained by the scanner 112, to rotate to return to the original orientation of 0 degree.

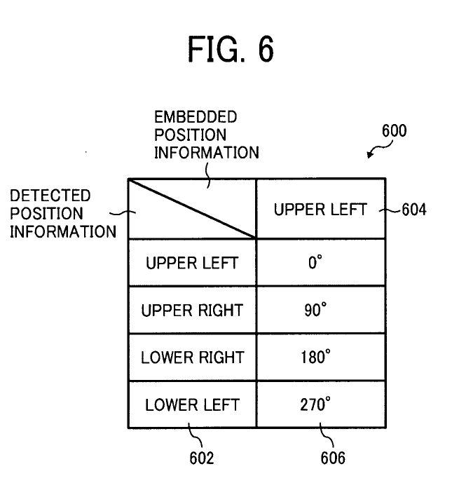

In this example, the image processor 122 may access a look-up table 600 shown in FIG. 6, which may be stored in the RAM 126, ROM 128, or the storage device 146, to obtain the rotation angle. The table 600 of FIG. 6 stores a plurality of rotation angle values 606 for a plurality of sets of the embedded position information 604 and the detected position information 602. With this data structure shown in FIG. 6, the rotation angle value 606, which corresponds to the difference between the position specified by the embedded position information 604 and the position specified by the detected position information 602, may be easily obtained. In this example, since the position specified by the embedded position information 604 is the upper left portion and the position specified by the detected position information 602 is the lower right portion, the rotation angle value 606 of 180 degrees may be obtained. The rotation angle value may be stored as attribute information in a corresponding manner with the image data being obtained, specifically, the image data 506 of FIG. 5D.

As described above referring to S404 of FIG. 4, the image processor 122 may perform image processing according to the control data. In this example, the image processor 122 rotates the image data 506 by the rotation angle value being obtained, which is 180 degrees, for example, by using the equation shown in FIG. 18 to generate output data. The output data may be stored in a memory such as the FIFO buffer.

Referring to the equation of FIG. 18, θ corresponds to the rotation angle in which the image data is rotated. X and Y each correspond to the X value and Y value of the image data being obtained by the scanner 112, such as a counted value or an address value obtainable from the XY coordinate system. Xr and Yr each correspond to the X value and Y value of the image data after being obtained after rotation, such as a counted value or an address value obtainable from the XY coordinate system.

The output data, which is obtained by rotating the image data 506 by the rotation angle of 180 degrees, may be sent to the image forming engine 142. In this manner, the image forming apparatus 100 is capable of outputting each page of the document with the upright position, even when image data being obtained from the document has an orientation different from the orientation of the document in the upright position.

Referring now to FIG. 7, operation of determining the value of a rotation angle based on control data, performed by the image forming apparatus 100 of FIG. 1, is explained according to an embodiment of the present invention. For the descriptive purpose, in this example operation, the image data 506 of FIG. 5D is assumed to be input as the image data of the document 500 shown in FIG. 5A.

At S701, the scanner 112 obtains the image data 506. In this example, before obtaining the image data 506, skew correction may be performed.

At S702, the image processor 122 determines whether the mark 510 is detected from a portion of the image data 506. When it is determined that the mark 510 is not detected (“NO” at S702), the operation proceeds to S706. When it is determined that the mark 510 is detected (“YES” at S702), the operation proceeds to S703. For example, the image processor 122 may first determine whether an upper left portion of the image data 506 contains the mark 510. When it is determined that the mark 510 is not detected from the upper left portion of the image data 506, the image processor 122 may determine whether any one of an upper right portion, a lower right portion, and a lower left portion of the image data 506 contains the mark 510, for example, by checking the edge portions of the image data 506 in a predetermined order, until the mark 510 is detected. When the mark 510 is detected, the image processor 122 may extract the mark 510 from the image data 506 and store the mark 510 in a memory.

S706 sets an image forming mode to the mode in which the control data is not used for image forming, such as a normal image forming mode. The image processor 122 sends the image data being obtained by the scanner 112 to the image forming engine 142, and the operation ends. The image forming engine 142 forms an image of the image data on a recording medium.

S703 determines whether the mark 510 being detected in the image data at S702 is decodable. When it is determined that the mark 510 is decodable (“YES” at S703), the operation proceeds to S707. When it is determined that the mark 510 is not decodable (“NO” at S703), the operation proceeds to S704.

In order to determine whether the mark 510 is decodable, the image processor 122 may determine whether the characteristics of the mark 510 being detected matches the characteristics of the mark 510 that has been embedded. The mark 510 or the characteristics of the mark 510 that has been embedded may be previously stored in a memory, for example, at the time of encoding the mark 510. Further, the characteristics of the mark 510 are assumed to be different depending on the orientation of the mark 510. In this example, the image processor 122 determines whether the characteristics of the mark 510 extracted from the image data 506 matches the characteristics of the mark 510 of the image data having the upright position.

S704 determines whether all possible rotation angles of the mark 510 have been considered. When it is determined that all rotation angles of the mark 510 have been considered (“YES” at S704), the operation ends. At this time, the image processor 122 may cause the input/output device 114 (FIG. 1) to report to the user that the mark 510 is not decodable, for example, by displaying an error message. Further, the input/output device 114 may ask the user whether to form an image of the image data without using the control data, or cancel image forming operation. Alternatively, the input/output device 114 may automatically form an image of the image data without using the control data, for example, as described above referring to S706 of FIG. 7.

When it is determined that all rotation angles of the mark 510 have not been considered (“NO” at S704), the operation proceeds to S705.

S705 selects a next rotation angle of the mark 510 to determine whether the mark 510 is decodable. For example, using the equation of FIG. 18, the image processor 122 may rotate the mark 510 or at least a portion of the image data 506 having the mark 510 by the selected rotation angle, and determines whether the mark 510 is decodable. More specifically, in this example, the image processor 122 rotates the mark 510 having the orientation of 0 degree, which is extracted from the image data 506, by 90 degrees to generate the mark 510 having the orientation of 90 degrees. The image processor 122 determines whether the mark 510 having the orientation of 90 degrees is decodable at S703.

In this manner, the mark 510 may be rotated, by a predetermined degree, until the mark 510 being extracted from the image data 506 matches the mark 510 being embedded. In this example, the mark 510 of the image data 506 is determined to match the mark 510 being embedded, when the mark 510 of the image data 506 is rotated by 180 degrees. When it is determined that the mark 510 is decodable at S703, the operation proceeds to S707.

S707 assumes that the mark 510, which is decodable, is extracted from the image data of the document 500 having the upright orientation. The image processor 122 may further set the value of the rotation angle that causes the image data 506 to rotate to be equal to the value of the rotation angle of the decodable mark 510, and the operation ends.

As described above referring to FIG. 4, the image processor 122 may rotate the image data 506 by the rotation angle of 180 degrees to generate output data. In this manner, the image forming apparatus 100 is capable of outputting each page of the document with the upright position, even when image data being obtained from the document has an orientation different from the orientation of the document in the upright position. Further, in this example described referring to FIG. 7, the image forming apparatus 100 does not have to be provided with a table, such as the table 600 of FIG. 6, to determine the rotation angle.

In this example, the value of the rotation angle that causes the image data to rotate may be determined by rotating the mark 510. Alternatively, the value of the rotation angle that causes the image data to rotate may be determined by rotating at least a portion of the image data 506 having the mark 510. Alternatively, the value of the rotation angle that causes the image data to rotate may be determined by changing the value of the rotation angle of the image bit map obtainable from the mark 510.

Referring now to FIGS. 8A to 8E, FIG. 9, and FIG. 10, operation of determining the value of a rotation angle based on the control data, performed by the image forming apparatus 100 of FIG. 1, is explained according to an example embodiment of the present invention.

In this example, the document 800 of FIG. 8A is assumed to be provided to the scanner 112, for example, by placing the document 800 onto the exposure glass of the scanner 112 or placing the document 800 onto the document tray of the ADF of the scanner 112. As illustrated in FIG. 8A, the document 800 is embedded with marks 810 including a first mark 810 embedded at the upper left portion, a second mark 810 embedded at the upper right portion, a third mark 810 embedded at the lower right portion, and a fourth mark 810 embedded at the lower left portion. Each of the marks 810 is generated by encoding control data, which includes embedded position information specifying that the mark 810 is added to the corresponding one of the upper left portion, upper right portion, lower right portion, and lower left portion of the image data of the document 800 when the document 800 is in the upright position. Further, in this example, the image data being obtained by the scanner 112 is assumed to be one of the image data shown in FIGS. 8B to 8E. For the descriptive purpose, in this example, the image data 806 of FIG. 8D is assumed to be input to the scanner 112.

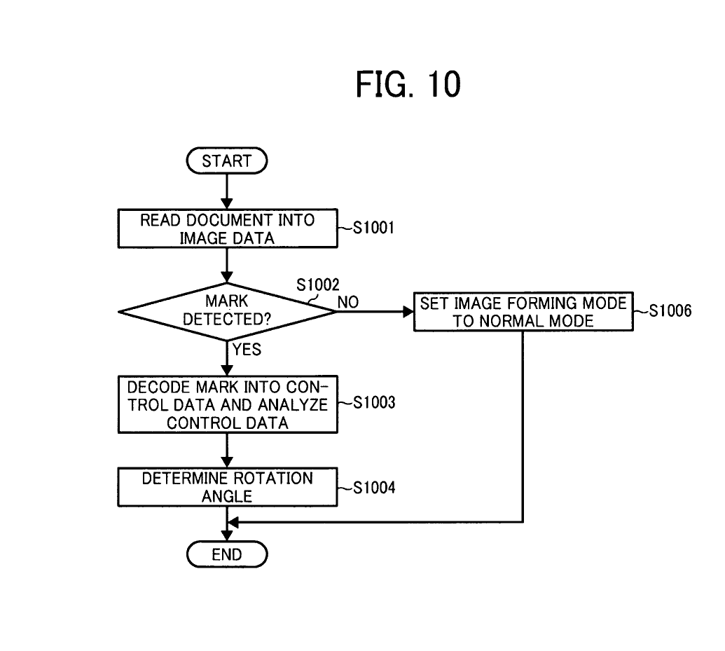

Referring to FIG. 10, at S1001, the scanner 112 obtains the image data 806 shown in FIG. 8D. In this example, before obtaining the image data 806, skew correction may be performed.

At S1002, the image processor 112 determines whether any one of the marks 810 is detected from a portion of the image data 806. When it is determined that the mark 810 is detected (“YES” at S1002), the operation proceeds to S1003. When it is determined that the mark 810 is not detected (“NO” at S1002), the operation proceeds to S1006. In this example, since the mark 810 is embedded into each one of the edge portions of the image data 806, the image processor 112 may look for the mark 810 in only one of the four edge portions, which may be previously specified, rather than checking for more than one portion until the mark is detected as described above referring to FIG. 7. The image processor 112 may extract the mark 810, which is detected first, and store the mark 810 in a memory. Compared to the example case described referring to FIG. 7, the time it may take to detect the mark may be reduced.

S1006 sets an image forming mode to the mode in which the control data is not used for image forming, such as the normal image forming mode. The image processor 122 sends the image data being obtained by the scanner 112 to the image forming engine 142, and the operation ends. The image forming engine 142 forms an image of the image data on a recording medium.

At S1003, the image processor 122 decodes the mark 810, which is firstly detected at S1002, to obtain the control data. In this example, the mark 810 at the upper left portion of the image data 806, which corresponds to the third mark 810 of the document 800, is assumed to be firstly detected. The control data includes the embedded position information specifying the portion of the image data 806 to which the third mark 810 is added, specifically, the lower right portion of the image data of the document 800 having the upright position. The image processor 122 may store the embedded position information of the third mark 810. Further, the image processor 122 may store detected position information specifying the portion of the image data 806 in which the third mark 810 is detected, specifically, the upper left portion of the image data 806.

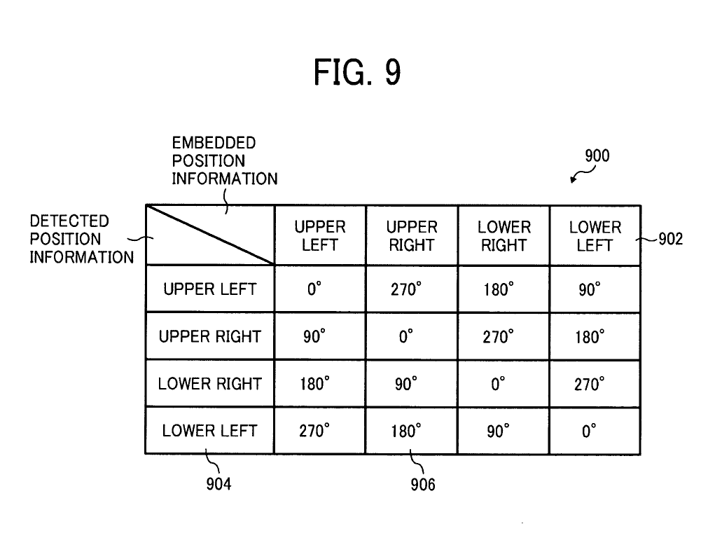

At S1004, the image processor 122 determines the value of a rotation angle that causes the image data 806, which is obtained by the scanner 112, to rotate to return to the original orientation of 0 degree. For example, the image processor 122 may access a look-up table 900 shown in FIG. 9, which may be stored in the RAM 126, ROM 128 or storage device 146, to obtain the value of the rotation angle. The table 900 of FIG. 9 stores a plurality of values of the rotation angle 906 with respect to a plurality of sets of the embedded position information 902 and the detected position information 904. In this example, since the position specified by the embedded position information 902 is the upper left portion and the position specified by the detected position information 904 is the lower right portion, the rotation angle 906 of 180 degrees may be obtained.

Once the value of the rotation angle is determined, the image processor 122 rotates the image data 806 by the rotation angle being obtained, which is 180 degrees, for example, by using the equation of FIG. 18 to generate output data, and the operation ends. The output data may be stored in a memory such as the FIFO buffer.

Operation of FIG. 10 may be performed in various other ways. For example, instead of referring to the look-up table 900 of FIG. 9, the image processor 122 may determine whether the mark 810 being detected is decodable in a substantially similar manner as described above referring to S703 of FIG. 7.

As described above, the image forming apparatus 100 is capable of outputting a plurality of pages of a document with a predetermined orientation, even when the document is provided with an orientation different from the predetermined orientation.

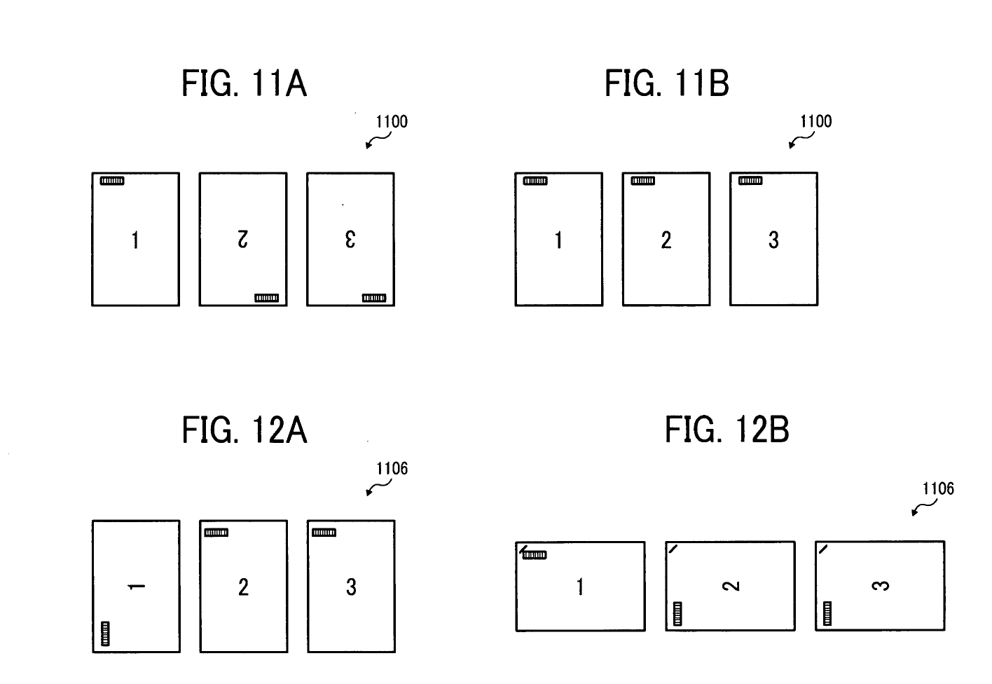

FIGS. 11A and 11B illustrate an example operation of changing the orientation of one or more pages of a document 1100 based on control data. Referring to FIG. 11A, a second page and a third page are rotated by 180 degrees at the time of being read by the scanner 112. As described above, the image forming apparatus 100 analyzes the control data extracted from each page, determines a rotation angle for each page, and rotates the image data of each page by the rotation angle. As illustrated in FIG. 11B, all pages of the document 1100 output by the image forming apparatus 100 have a predetermined orientation. With this function of the image forming apparatus 100, the user does not have to check whether all pages of the document 1100 have a predetermined orientation when providing the document 1100 to the scanner 112.

FIGS. 12A and 12B illustrate an example operation of changing the orientation of one or more pages of a document 1106 to prepare for post processing based on control data. As described above referring to FIG. 2, the control data may include any desired kind of information other than the embedded position information specifying the portion of the image data to which the control data is added. In this example, the control data includes embedded position information specifying that the control data is added to the upper left portion of the image data, and printing property information indicating that stapling is performed on the upper left portion of the document having the landscape orientation.

Referring to FIGS. 12A and 12B, the first page of the document 1106 has the landscape orientation, while the second and third pages of the document 1106 each have the portrait orientation. At the time of scanning, as illustrated in FIG. 12A, the first page of the document 1106 is rotated by 180 degrees at the time of being read by the scanner 112. As described above, the image forming apparatus 100 analyzes the control data extracted from each page, determines a rotation angle for each page, and rotates the image data of each page by the rotation angle.

In this example, the image processor 122 may firstly determine a rotation angle that causes the image data to return to the upright position as described above, for example, referring to FIG. 7 or FIG. 10. As illustrated in FIG. 12B, the first page of the document 1106 may be rotated by the rotation angle of 90 degrees, which may be obtained based on the embedded position information obtainable from the mark extracted from the image data of the first page. The second and third pages of the document 1106 are not rotated as the control data indicates that the second and third pages already have the upright position.

Further, the image processor 122 may further rotate the image data to prepare for stapling, based on the printing property information decodable from the mark. As illustrated in FIG. 12B, the first page of the document 1106 is not rotated as the first page of the document 1106 has the landscape orientation. The second and third pages of the document 1106 are each rotated by the rotation angle of 270 degrees such that the direction of printing the second and third pages of the document 1106 is consistent with the direction of printing the first page of the document 1106. With this function of the image forming apparatus 100, the user does not have to check whether all pages of the document 1106 have a predetermined orientation, even when the document 1106 including a plurality of pages of different types is subjected for post processing.

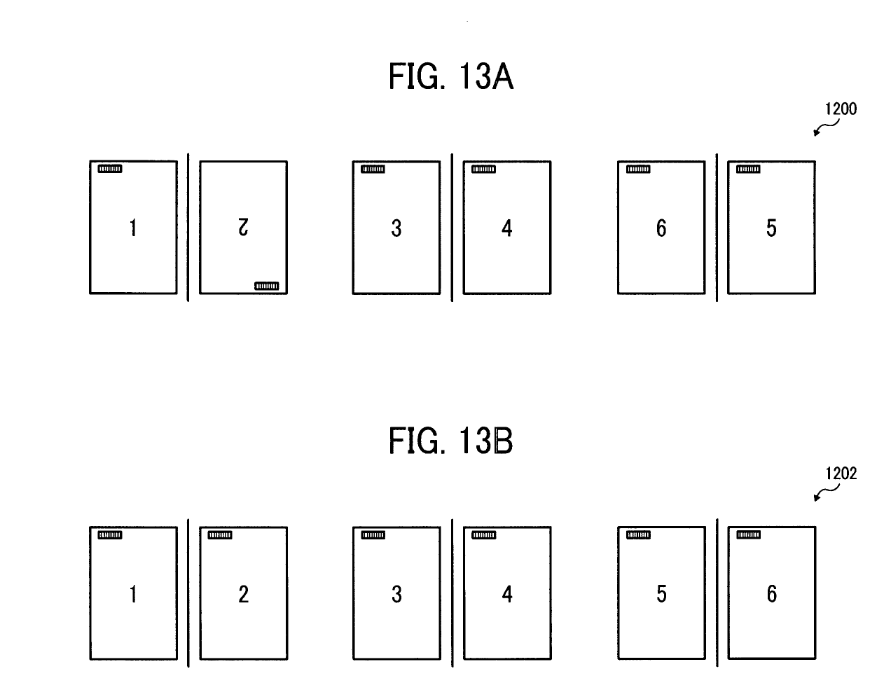

FIGS. 13A and 13B illustrate an example operation of changing the orientation and/or arrangement order of one or more pages of a document 1200 based on control data. In this example, the control data includes embedded position information specifying that the control data is added to the upper left portion of the image data, double-sided information indicating that the image data is to be printed on both sides of the recording medium and specifying the direction of opening as right to left, and page number information indicating the page number assigned to each page of the document 1200.

Referring to FIG. 13A, the second page of the document 1200, which is formed on the reverse side of the first page, is rotated by 180 degrees at the time of being read by the scanner 112 as the direction of opening is from the above to the bottom. The fifth page and the sixth page of the document 1200 are input in the reverse order as the double-sided page containing the fifth page on one side and sixth page on the other side is provided upside-down.

As described above, the image processor 122 analyzes the embedded position information extracted from each page, determines a rotation angle for each page, and rotates the image data of each page by the rotation angle. Further, the image processor 122 analyzes the page number information extracted from each page, determines whether an order in which the pages of the document 1200 are arranged matches the page number information, and rearranges the order in which the pages are arranged so as to match the page number information. Further, the image processor 122 analyzes the double-sided information, and determine whether to further rotate the image data.

For example, in the case of the fifth page and the sixth page of FIG. 13A, which are input in the reverse order, the image processor 122 obtains the page number being assigned to each page from the control data. As illustrated in FIG. 13A, the fifth page of the document 1200 is assigned with the page number 6, and the sixth page of the document 1200 is assigned with the page number 5. The image processor 122 determines whether any one of the fifth page and the sixth page are arranged in a predetermined order according to the page number being assigned. When it is determined that the fifth and sixth pages are not arranged in the predetermined order, the image processor 122 rearranges the order of the fifth and sixth pages to be in compliance with the page number being assigned, for example, as illustrated in FIG. 13B. With this function of the image forming apparatus 100, the user does not have to check whether all pages of the document 1202 have a predetermined orientation or whether all pages of the document 1202 are arranged in a predetermined order, even when double-sided printing is performed from the double-sided originals.

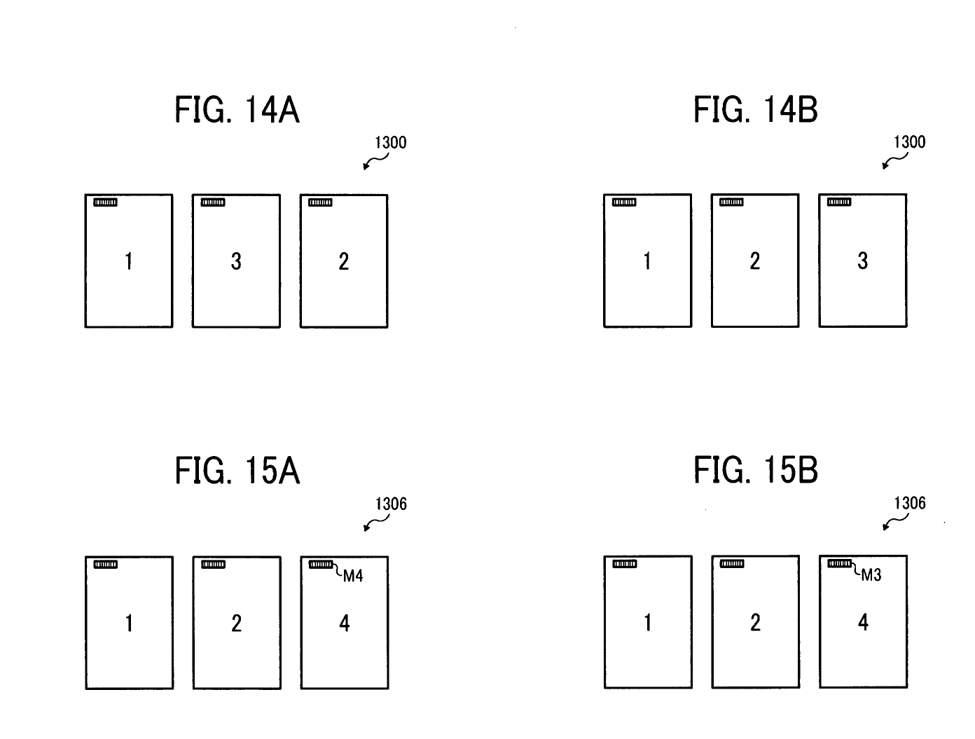

FIGS. 14A and 14B illustrate an example operation of changing the order of arrangement of one or more pages of a document 1300 based on control data. In this example, the control data includes page number information indicating the page number assigned to each page of the document 1300.

Referring to FIG. 14A, the third page and the second page of the document 1300 are input in the reverse order. As described above, the image processor 122 analyzes the page number information extracted from each page, and determines whether the page number information matches the order in which the pages of the document 1300 are obtained by the scanner 112. When it is determined that the order in which the pages of the document 1300 are obtained by the scanner 112 does not match the order of pages obtainable from the page number information extracted from the document 1300, the image processor 122 rearranges the order of pages by referring to the page number being assigned to each page of the document 1300 to generate output data. As illustrated in FIG. 14B, the pages of the document 1300, which may be output by the image forming engine 142, are arranged according to the page number being assigned. With this function of the image forming apparatus 100, the user does not have to check whether all pages of the document 1300 are arranged in a predetermined order. In this example shown in FIG. 14B, the pages are sorted from the smallest page number to the largest page number. Alternatively, the pages may be sorted from the largest page number to the smallest page number, for example, according to the default settings or settings set by the user.

FIG. 15A illustrates an example case in which one page of the pages of a document 1306 is not obtained by the scanner 112. Referring to FIG. 15A, the third page is not obtained by the scanner 112. For example, the third page may not have been provided by the user either intentionally or unintentionally. In another example, the third page may not have been read by the scanner 112, for example, due to the reading error. When the image forming apparatus 100 detects that the third page of the document 1306 is missing by checking the page number information extracted from each one of the pages of the document 1306, the image forming apparatus 100 may report to the user, for example, by displaying an error message through the input/output device 114. In this example, the page number information regarding a total number of pages of the document 1306 or the page number information regarding the last page of the document 1306 may be encoded as the control data into the mark, in addition to the page number information indicating the page number being assigned to each page of the document 1306.

Together with the error message or after displaying the error message, the image forming apparatus 100 may provide the user with a plurality of options through the input/output device 114. Such options may include a first option of printing image data as is, a second option of inserting the third page by requesting the user to provide the third page, and a third option of changing the page number being assigned to the fourth page from the page 4 to the page 3.

For example, when the third option is selected through the input/output device 114, as illustrated in FIGS. 15A and 15B, the image processor 122 deletes the mark M4 being embedded into the image data of the fourth page, which includes page number information specifying the page 4. The image processor 122 generates a mark M3 in which page number information specifying the page 3 is encoded, and adds the mark M3 to the image data of the fourth page.

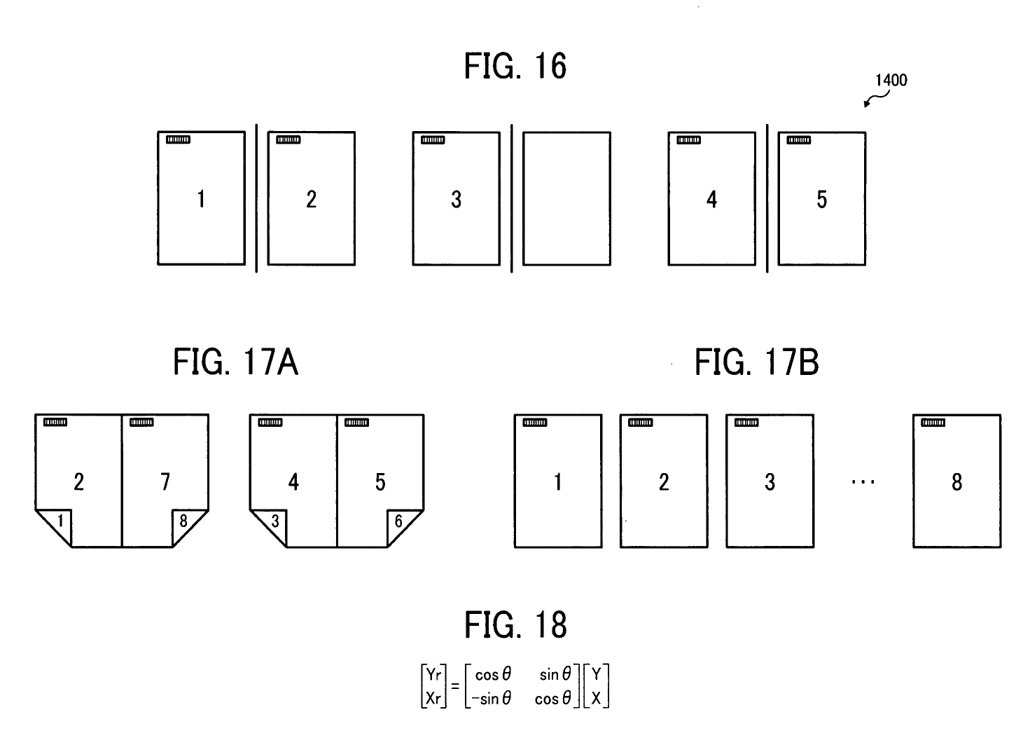

FIG. 16 illustrates an example case in which one blank page is detected from a plurality of pages of a document 1400. The blank page, which is obtained after the third page is obtained, is not encoded with the mark.

When the image forming apparatus 100 detects the blank page, for example, by detecting the page embedded with no mark, the image forming apparatus 100 may report to the user, for example, by displaying an error message through the input/output device 114.

Together with the error message or after displaying the error message, the image forming apparatus 100 may provide the user with a plurality of options through the input/output device 114. Such options may include a first option of forming the image of the third page on one side of the recording medium, a second option of forming the image of the fourth page on the other side of the recording medium having the image of the third page formed on one side without changing the page number information, and a third option of changing the page number information embedded into the image data of the fourth page and forming the fourth page on the reverse side of the third page. This may prevent the image forming resource, such as the recording medium, from being wasted. This may further prevent the image forming apparatus 100 from performing image processing or image forming, which may be considered as meaningless.

FIGS. 17A and 17B illustrate an example operation of changing the arrangement order of one or more pages of a document. Referring to FIG. 17A, a plurality of pages are obtained from a bound document such as a magazine or a book. Since each page of the document is embedded with a mark including page number information, the image forming apparatus 100 may rearrange the order of pages according to the page number information, and output the pages in the order from the smallest number to the largest number as illustrated in FIG. 17B. In this manner, the image forming apparatus 100 is capable of outputting a plurality of pages of a document in a predetermined order, even when the document is bounded.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

For example, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc. Further, the above-described and other methods of the present invention may be written using any desired programming language, including the legacy programming language such as the assembler, C, C++, or Java, or the object-oriented programming language.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. An image forming apparatus, comprising:
a scanner device configured to obtain image data from a document that is assumed to be embedded with control data, the control data including embedded position information specifying a first portion of the image data to which the control data is embedded when the image data has a first orientation; and
an image processing device configured to analyze, when the control data is detected in the image data, the embedded position information to determine the value of a rotation angle that causes the image data to rotate from a second orientation to the first orientation, the second orientation corresponding to an orientation of the image data being obtained by the scanner device.

2. The apparatus of claim 1, wherein the image processing device is further configured to obtain detected position information specifying a second portion of the image data having the second orientation in which the control data is detected, and wherein the value of the rotation angle is determined based on the embedded position information and the detected position information.

3. The apparatus of claim 2, further comprising:
a storage device configured to store a plurality of values of the rotation angle with respect to a plurality of sets of the embedded position information and the detected position information,
wherein the value of the rotation angle is set to be equal to one of the plurality of values of the rotation angle being stored in the storage device.

4. The apparatus of claim 1, wherein the image processing device is further configured to determine whether the control data being detected in the image data having the second orientation is decodable to generate a first determination result, and wherein the value of the rotation angle is determined based on the first determination result.

5. The apparatus of claim 2, wherein the second portion of the image data having the second orientation in which the control data is detected is a portion of the image data in which the image processing device is configured to firstly look for the control data.

6. The apparatus of claim 1, wherein the control data further includes page number information, the page number information at least indicating a page number assigned to each one of a plurality of pages of the document,
and wherein the image processing device is further configured to determine whether an order in which the scanner device obtains the image data of the plurality of pages of the document matches an order specified by the page number information to generate a second determination result, and change the order in which the image data of the plurality of pages of the document is arranged according to the page number information based on the second determination result.

7. The apparatus of claim 6, wherein the image processing device is further configured to determine whether a total number of the plurality of pages of the document being obtained by the scanner device is equal to a total number of the plurality of pages of the document obtainable from the page number information to generate a third determination result, and report the third determination result to a user when the third determination result indicates that the total number of the plurality of pages of the document being obtained by the scanner device is not equal to the total number of the plurality of pages of the document obtainable from the page number information.

8. The apparatus of claim 7, wherein the image processing device is further configured to change the page number information of the control data of at least one page of the plurality of pages of the document, when the third determination result indicates that the total number of the plurality of pages of the document being obtained by the scanner device is less than the total number of the plurality of pages of the document obtainable from the page number information.

9. The apparatus of claim 6, wherein the image processing device is further configured to determine whether at least one of the plurality of pages of the document is not embedded with the control data to generate a fourth determination result, and report the fourth determination result to a user when the fourth determination result indicates that the at least one of the plurality of pages of the document is not embedded with the control data.

10. An image forming method, comprising:
obtaining image data from a document that is assumed to be embedded with control data, the control data including embedded position information specifying a first portion of the image data to which the control data is embedded when the image data has a first orientation; and
analyzing, when the control data is detected in the image data, the embedded position information to determine the value of a rotation angle that causes the image data to rotate from a second orientation to the first orientation, the second orientation corresponding to an orientation of the image data being obtained by the scanner device.

11. The method of claim 10, further comprising:
obtaining detected position information specifying a second portion of the image data having the second orientation in which the control data is detected,
wherein the value of the rotation angle is determined based on the embedded position information and the detected position information.

12. The method of claim 11, further comprising:
storing a plurality of values of the rotation angle with respect to a plurality of sets of the embedded position information and the detected position information,
wherein the value of the rotation angle is set to be equal to one of the plurality of values of the rotation angle being stored.

13. The method of claim 10, further comprising:
determining whether the control data being detected in the image data having the second orientation is decodable to generate a first determination result,
wherein the value of the rotation angle is determined based on the first determination result.

14. The method of claim 10, further comprising:
obtaining, from the control data, page number information at least indicating a page number assigned to each one of a plurality of pages of the document;
determining whether an order in which the image data of the plurality of pages of the document matches an order specified by the page number information to generate a second determination result; and
changing the order in which the image data of the plurality of pages of the document is arranged according to the page number information based on the second determination result.

15. The method of claim 14, further comprising:
determining whether a total number of the plurality of pages of the document being obtained by the scanner device is equal to a total number of the plurality of pages of the document obtainable from the page number information to generate a third determination result; and
reporting the third determination result to a user when the third determination result indicates that the total number of the plurality of pages of the document being obtained by the scanner device is not equal to the total number of the plurality of pages of the document obtainable from the page number information.

16. The method of claim 15, further comprising:
changing the page number information of the control data of at least one page of the plurality of pages of the document, when the third determination result indicates that the total number of the plurality of pages of the document being obtained by the scanner device is less than the total number of the plurality of pages of the document obtainable from the page number information.

17. The method of claim 14,further comprising:
determining whether at least one of the plurality of pages of the document is not embedded with the control data to generate a fourth determination result; and
reporting the fourth determination result to a user when the fourth determination result indicates that the at least one of the plurality of pages of the document is not embedded with the control data.

18. The method of claim 10, wherein the obtaining image data from a document that is assumed to be embedded with control data and the analyzing when the control data is detected in the image data the embedded position information are performed concurrently.

19. The method of claim 10, wherein the obtaining image data from a document that is assumed to be embedded with control data comprises:
determining information to be embedded as the control data; and
adding the control data to the first portion of the image data of the document.

20. An image forming apparatus, comprising:
a document input device configured to obtain image data of a document;
an image processing device configured to embed control data to a portion of the image data to generate output data; and
an output device configured to output the output data,
wherein the control data includes at least one of information selected from:
embedded position information specifying the portion of the image data to which the control data is embedded;
page number information indicating at least a page number assigned to each page of the original document; and
printing property information controlling image processing or image forming of the image data.
